(19) United States
(12) Patent Application Publication
(10) Pub. No.: US 2025/0308771 A1
(43) Pub. Date: Oct. 2, 2025

(54) Method and device for producing a tape-wound toroidal core

(71) Applicants: Ulf SCHMIDTGEN, Fürth (DE); Wolfgang ZÄNGLEIN, Würzburg (DE)

(72) Inventor: Ulf SCHMIDTGEN, Fürth (DE)

(21) Appl. No.: 18/865,097

(22) PCT Filed: May 15, 2023
(86) PCT No.: PCT/EP2023/063028

§ 371 Date: Nov. 12, 2024

(30) Foreign Application Priority Data
May 13, 2022 (DE) 10 2022 112 113.5

(51) Int. Cl. H01F 41/02; B65H 23/182

(52) U.S. Cl. CPC H01F 41/022; B65H 23/1825; B65H 2404/69; B65H 2701/37

(57) ABSTRACT

A method for producing a tape-wound toroidal core includes: ⋅providing a soft-magnetic tape on two tape reels, ⋅unwinding the tape and winding the tape onto two winding mandrels to form a multilayer first tape roll, wherein, after in each case several layers, a separating plate is inserted into the first tape rolls that have formed, ⋅reducing the distance between the winding mandrels until the first tape rolls touch each other, ⋅unwinding the tape and winding up the tape to form a multilayer second tape roll, which wraps around the first tape rolls, by rotating the winding mandrels about a common second rotation axis, ⋅severing the tape rolls in steps to form a plurality of tape sections, ⋅picking up at least one reel and placing the reel onto the tape sections, ⋅reshaping free ends of the tape sections and connecting the ends of the tape sections to form a closed ring.

### CROSS-REFERENCE TO RELATED APPLICATION

This application is a national stage application, filed under 35 U.S.C. § 371, of International Patent Application PCT/EP2023/063028, filed on May 15, 2023, which claims the benefit of German Patent Application DE 10 2022 112 113.5, filed on May 13, 2022.

### TECHNICAL FIELD

The disclosure relates to methods and apparatuses for producing a tape-wound toroidal core as is used, for example, for transformers or chokes.

### BACKGROUND

Chokes are coils or inductors for limiting currents in electrical lines, for temporarily storing energy in the form of their magnetic field, for adjusting impedance or for filtering. Most chokes have a magnetic core because they then require substantially fewer turns for the same inductance than air chokes.

Transformers usually consist of two or more coils, which are usually wound from insulated copper wire and are located on a common magnetic core. They are used, for example, for voltage conversion in power supply systems and in technical devices. They are also required for signal transmission and protective separation.

Magnetic cores consist of a soft-magnetic material with the highest possible magnetic saturation flux density and high magnetic permeability. As a result, the magnetic flux generated during current flow through the electrical conductor of the coil is bundled, guided and the inductance increased with little loss. A high permeability increases the magnetic field of an inductor by up to five powers of ten compared to an inductor with air as the core, making the dimensions of the inductor with a magnetic core smaller than in the case of an air coil.

As a measure against eddy current losses, magnetic cores of transformers and electric motors are laminated, rather than being solid. These embossed or cut electrical sheets are coated with a heat-resistant and insulating lacquer and, oriented parallel to the magnetic field lines, laminated into blocks or rolled into rings. The magnetic flux is thus distributed across individual, mutually separate flows in the individual sheets, in which only smaller eddy currents can thus form, the total power loss of which is significantly lower than in a solid material. The sheets are usually thinner than 1 mm. The thinner the sheet, the lower the eddy current losses are or the higher the operating frequency may be.

Laminated magnetic cores are primarily used in the low frequency range of 16 to 400 Hz. However, wound tape cores with tape thicknesses of about 20 μm can be used up to 100 kHz. For frequencies in the high frequency range, however, powder cores or ferrites are predominantly used for the cores of transformers, coils and chokes.

Tape cores are wound from a thin soft-magnetic tape with a thickness between 20 μm and 1 mm (typically and depending on the alloy). The simplest and most cost-effective form in manufacturing is a tape-wound toroidal core. With the exception of the negligible transition between the tape layers, an ideal, self-contained magnetic circuit with a uniform cross section is therefore created. The dynamic properties are substantially controlled by the alloy used and the tape thickness.

Tape-wound toroidal cores are usually made from a long tape, which typically firstly has to be cut to the appropriate width. They are therefore also called tape-wound cut cores. The tape is wound up into a core using a winding machine. The winding is followed by a heat treatment, in which the magnetic properties of the core are adjusted or achieved, of between approx. 200° C. and 600° C., depending on the alloy. During the heat treatment, the material changes not only magnetically, but also mechanically. Amorphous and nanocrystalline alloys are fairly brittle after the heat treatment and may therefore also be easily damaged mechanically.

### SUMMARY

In the following, improved methods and apparatuses for producing a tape-wound toroidal core are proposed.

A proposed apparatus for producing a tape-wound toroidal core comprises:
a winding device with two rotationally drivable winding mandrels arranged at a distance from each other for winding up the tape, wherein the winding mandrels are selectively rotationally drivable about in each case a first axis of rotation or about a common second axis of rotation, and wherein the winding mandrels are movable perpendicular to the axes of rotation for adjusting the distance between them,
two tape feeding devices, each having at least one tape coil for providing a soft-magnetic tape,
an insertion device having at least one manipulator for inserting separating plates into a tape roll being formed, and
at least one separating device for gradual and offset cutting through the tape roll to form a plurality of tape sections.

Other aspects of the proposed apparatus make provision
that the tape feeding devices each comprise at least two tape coils for providing soft-magnetic tape of differing width;
that the tape feeding devices each have a multi-coil magazine, to which at least two tape coils are interchangeably attachable;
that a tape tensioning device for maintaining a predeterminable tape tension is provided;
that a coating device for applying an insulation layer or connecting layer to the tape can be provided;
that a coil feeding device with a manipulator for picking up and depositing coils on the tape sections is provided;
that a closing device with a manipulator for reshaping free ends of the tape sections into a closed ring is provided;
that the closing device comprises a manipulator for attaching a tensioning tape enclosing the entire magnetic core.

A proposed method for producing a tape-wound toroidal core comprises the following steps:
providing a soft-magnetic tape on at least two tape coils,
unwinding the tape from two tape coils and winding up the tape onto two winding mandrels arranged at a distance from each other to form in each case a multi-layer first tape roll by rotating the winding mandrels about a respective first axis of rotation, wherein, after in each case a plurality of layers, a separating plate is inserted into the first tape rolls being formed,
reducing the distance between the winding mandrels until the first tape rolls touch each other,
unwinding the tape from two tape coils and winding up the tape to form a multi-layer second tape roll which loops around the first tape rolls by rotating the winding mandrels about a common second axis of rotation, wherein, after in each case a plurality of layers, a separating plate is inserted into the second tape roll being formed,
gradually cutting through the tape rolls to form a plurality of tape sections,
picking up at least one coil and depositing the coil on the tape sections,
reshaping free ends of the tape sections and connecting the ends of the tape sections to form a closed ring.

Other aspects of the proposed apparatus make provision
that, for each winding mandrel, tapes of differing width are provided on in each case at least two tape coils;
that, between the unwinding and the winding up of the tape, an insulation layer or connecting layer can be applied to the tape;
that, in a final step, a tensioning tape enclosing the entire magnetic core, or a tensioning structure is attached;
that the first tape rolls on the winding mandrels are formed from at least two tapes of differing width with an increasing width from the inside to the outside and the second tape roll is formed on the first tape rolls in the same way from at least two tapes of differing width with a decreasing width from the inside to the outside.

### BRIEF DESCRIPTION OF THE DRAWINGS

In the following, the apparatus and the method will be explained in more detail in an exemplary embodiment with reference to drawing figures, in which:

FIGS. 1a to 1d show the schematic sequence of the winding up of the tape in a view from the front,

FIGS. 2a and 2b show the schematic sequence of the winding up of the tape in a view from above, and

FIGS. 3a to 3f show the schematic sequence of cutting through the tape rolls, fixing the coils and connecting the tape sections.

### DETAILED DESCRIPTION

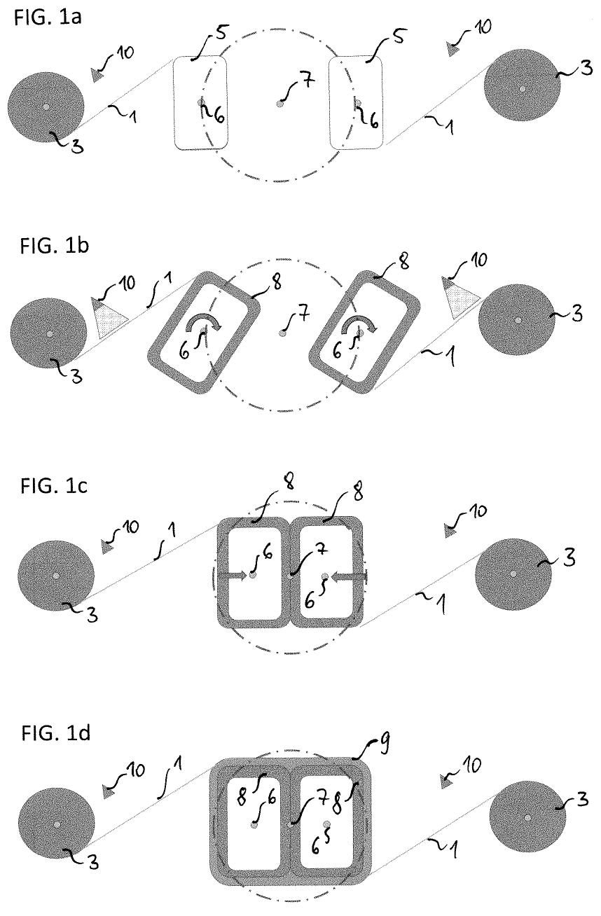

The illustrations in FIGS. 1a to 1d show, in a view from the front, an apparatus for producing a tape-wound toroidal core with two tape coils 3 for providing a thin soft-magnetic tape 1 and with two rotationally drivable winding mandrels 5 for winding up the tape 1 to form multi-layer tape rolls 8, 9, the distance of which from each other is adjustable, and with two nozzles 10 of a coating device for applying an insulation layer or connecting layer to the tape 1. The winding mandrels 5 are rotationally drivable separately about a respective first axis of rotation 6 or together about a second axis of rotation 7, wherein the first axes of rotation 6 and the second axis of rotation 7 are aligned parallel to each other. In cross section, the winding mandrels 5 have a rectangular shape adapted to the transformer to be produced, with it being possible for frame elements 14 of a holding frame to already be inserted into the winding mandrels 5. Whether the tapes 1 are used as single tapes or as multiple tapes is irrelevant for the proposed method. It merely affects the productivity of the proposed apparatus.

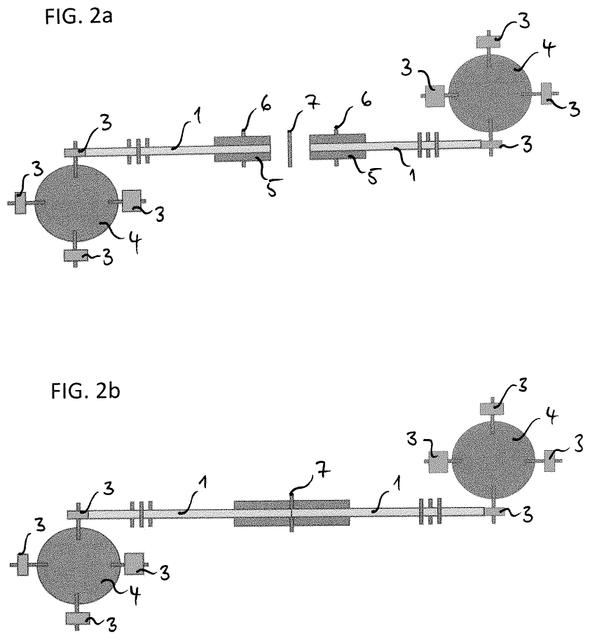

As illustrated in FIGS. 2a and 2b, in a view from above, the tape feeding device for each winding mandrel 5 not only has an individual tape coil 3, but also a respective multi-coil magazine 4, to which four tape coils 3 having a tape 1 of differing width can be interchangeably attached. Thus, the first tape rolls 8 can be formed on the winding mandrels 5 from up to four tapes of differing width with an increasing width from the inside to the outside by shifting the multi-coil magazine 4 after a certain number of layers of a tape 1 of a certain width such that winding subsequently proceeds with a tape 1 of larger width. The winding up is started with the narrowest tape 1. When the desired thickness of this tape 1 is reached, the winding is interrupted, the tape 1 is cut and the next wider tape 1 is coupled to the narrow tape 1 (e.g. with double-sided adhesive tape) and then the winding operation continues.

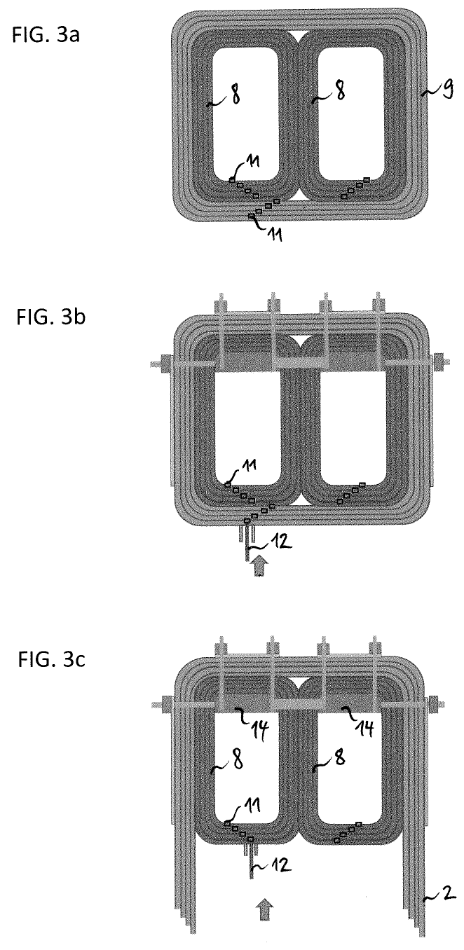

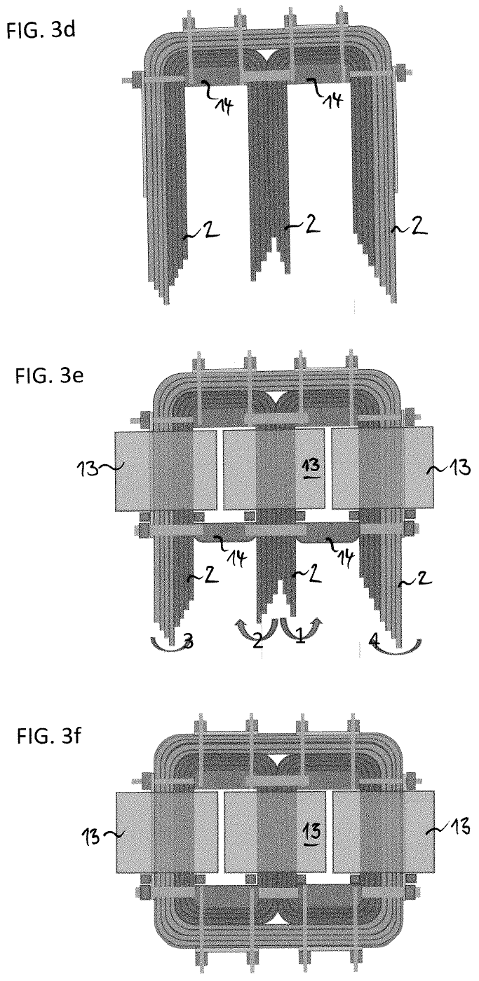

For the subsequently required separation operation, during the winding up of the tape 1 to form two first tape rolls 8, in each case after a tape roll thickness of, for example, approx. 5 mm, separating plates 11, which are illustrated in FIGS. 3a to 3c, are inserted. The separating plates 11 are intended to prevent the material layer located underneath from being cut during a separation cut. The separating plate 11 can be made of diverse materials, since it is removed after the separation cut. It is irrelevant whether the separating plate 11 is cut into or whether there is a clearance in the separating plate 11 at the separation point. The separating plate 11 can advantageously be made from a permanent magnet, as a result of which easy fixing and also an easy removal after the separation cut is possible. In the case of a permanent-magnetic design, a clearance should be provided.

Once the desired thickness of the second tape width has been reached, the procedure is carried out in the same way with the third and fourth tape widths. However, for the last (widest) tape width, only up to half the desired thickness is wound. The winding up of the tape 1 onto the winding mandrels 5 by rotation about the respective first axis of rotation 6 is illustrated in FIG. 1b and FIG. 2a.

The winding device is then stopped and the winding mandrels 5 are moved toward each other in a plane perpendicular to the axes of rotation 6, 7 until the first tape rolls 8 touch each other (illustrated in FIG. 1c and FIG. 2b). The unwinding of both tape feeding devices simultaneously onto the two previously produced first tape rolls 8 is then carried out by the two winding mandrels 5 being rotationally driven together about the second axis of rotation 7 arranged between them, such that a second tape roll 9 enclosing the two first tape rolls 8 is formed (illustrated in FIG. 1d and FIG. 2b).

The tape width is reduced by one step each time the desired thickness is reached. This results in an overall ovalized core cross-sectional geometry.

In the same way, as already described above, when the tape 1 is wound up to form a second tape roll 9, upon reaching the respective desired layer thickness, separating plates 11 are positioned at the desired separation points and inserted into the second tape roll 9 being formed.

If coating of the tape 1 with an insulation layer or connecting layer is required, this can be applied continuously during the winding operation. In this case, however, a multi-layer tape 1 should not be used. After the end of the winding operation, a tape roll 8, 9 is present, as illustrated in FIG. 3a.

After completion of the winding operation, the (upper) part of the core holding device 14 is mounted, as shown in FIG. 3b. The core can then be removed from the apparatus and the tape roll 8, 9 has to be cut in order to position and fix the coils 13. FIG. 3b illustrates how the separating device 12 cuts straight through the first winding layers of the outer, second tape roll 9 as far as an inserted separating plate 11. In FIG. 3c, all the winding layers of the outer, second tape roll 9 are cut through and the separating device is therefore just beginning to cut through the first winding layers of one of the two inner, first tape rolls 8 as far as an inserted separating plate 11.

The tape roll 8, 9 is cut through by a separating device 12, for example by means of a cutting wheel. The separation operation is carried out with the smallest possible cutting width (for example, approx. 1-2 mm) at the points where the separating plates 11 have been inserted, from the outside as far as the separating plate 11 in each case.

The cut ends of the tape sections 2 then drop down due to gravity and release the next separation point. After all the separation operations have been completed and the free ends of the tape sections 2 produced by the separation hang down (FIG. 3d), coils 13 can be pushed onto the free ends of the tape sections 2 or the coils 13 are positioned ready and the free ends of the tape sections 2 are lowered into the coils 13 (FIG. 3e).

The (lower) part of the holding device 14 is then positioned at the core and fixed (FIG. 3e), then the open legs 2, starting from the center, are closed (FIG. 3f). The positioning is provided in such a way that the free ends of the tape sections 2 virtually strike against each other; this is possible by engagement of the lower holding frame 14 around half of the cutting width in the direction of the upper holding frame 14.

To assist the closing operation, a tensioning tape should be placed around the ready wound transformer core, which may already have been fixed in the upper holding frame 14.

After closing of the core ring, the lower holding frame 14 is completed (FIG. 3f). This creates the basic structure of the transformer consisting of core, coil 13 and holding frame 14.

If the core is intended to be supplied as a partial product to a transformer manufacturer, the lower holding frame 14 may already be installed before cutting. However, the lower holding frame 14 then has to be removed to install the coils 13 and mounted again.

### LIST OF REFERENCE SIGNS

1 soft-magnetic tape
2 tape section
3 tape coil
4 multi-coil magazine
5 winding mandrel
6 first axis of rotation
7 second axis of rotation
8 first tape roll
9 second tape roll
10 coating nozzles
11 separating plate
12 separating device
13 coil
14 holding frame elements

1.-14. (canceled)

15. An apparatus for producing a tape-wound toroidal core, comprising:
a winding device with two rotationally drivable winding mandrels (5) arranged at a distance from each other for winding up a soft-magnetic tape (1),
wherein the two rotationally drivable winding mandrels (5) are selectively rotationally drivable about a respective first axis of rotation (6) each or about a common second axis of rotation (7), and
wherein the two rotationally drivable winding mandrels (5) are each movable perpendicular to the respective first axis of rotation (6) and the common second axis of rotation (7) for adjusting the distance between them;
two tape feeding devices, each having at least one tape coil (3) for providing the soft-magnetic tape (1);
an insertion device having at least one manipulator for inserting separating plates (11) into a tape roll (8, 9) being formed; and
at least one separating device (12) for cutting through the tape roll (8, 9) to form a plurality of tape sections (2).

16. The apparatus as claimed in claim 15,
wherein the at least one tape coil (3) of each of the two tape feeding devices comprises at least two tape coils (3) for providing the soft-magnetic tape (1) in differing widths.

17. The apparatus as claimed in claim 16,
wherein the tape feeding devices each have a multi-coil magazine (4), to which
the at least two tape coils (3) are interchangeably attachable.

18. The apparatus as claimed in claim 15,
further comprising a tape tensioning device for maintaining a predeterminable tape tension.

19. The apparatus as claimed in claim 15,
further comprising a coating device (10) for applying an insulation layer or
connecting layer to the soft-magnetic tape (1).

20. The apparatus as claimed in claim 15,
further comprising a coil feeding device with a manipulator for picking up and depositing coils (13) on the tape sections (2).

21. The apparatus as claimed in claim 15,
further comprising a closing device with a manipulator for reshaping free ends of the tape sections (2) into a closed ring.

22. The apparatus as claimed in claim 21,
wherein the closing device comprises a manipulator for attaching a tensioning tape enclosing an entire magnetic core.

23. A method for producing a tape-wound toroidal core, comprising:
providing a soft-magnetic tape (1) on at least two tape coils (3);
unwinding the soft-magnetic tape (1) from the at least two tape coils (3) and
winding up the soft-magnetic tape (1) onto two winding mandrels (5) arranged at a distance from each other to form in each case a multi-layer first tape roll (8) by rotating the winding mandrels (5) about a respective first axis of rotation (6);
inserting, after in each case a plurality of layers, a separating plate (11) into the multi-layer first tape rolls (8) being formed;
reducing the distance between the two winding mandrels (5) until the multi-layer first tape rolls (8) touch each other;
unwinding the soft-magnetic tape (1) from the at least two tape coils (3) and
winding up the soft-magnetic tape (1) to form a multi-layer second tape roll (9) which loops around the multi-layer first tape rolls (8) by rotating the winding mandrels (5) about a common second axis of rotation (7);
inserting, after in each case a plurality of layers, a separating plate (11) into the multi-layer second tape roll (9) being formed;
gradually cutting through the tape rolls (8, 9) to form a plurality of tape sections (2);
picking up at least one coil (13) and depositing the at least one coil (13) on the tape sections (2); and
reshaping free ends of the tape sections (2) and connecting the free ends of the tape sections (2) to form a closed ring.

24. The method as claimed in claim 23,
wherein, for each winding mandrel (5), tapes (1) of differing width are provided on in each case the at least two tape coils (3).

25. The method as claimed in claim 23, further comprising
applying an insulation layer or connecting layer to the tape between the unwinding and the winding up of the tape (1).

26. The method as claimed in claim 23, further comprising
attaching a tensioning tape enclosing an entire magnetic core.

27. The method as claimed in claim 23,
wherein the multi-layer first tape rolls (8) on the winding mandrels (5) are formed from at least two tapes (1) of differing width with an increasing width from an inside to an outside, and
wherein the multi-layer second tape roll (9) is formed on the multi-layer first tape rolls (8) from at least two further tapes (1) of differing width with a decreasing width from an inside to an outside.

28. The method as claimed in claim 27,
wherein at least four tapes (1) of differing width are used to form a magnetic core with an at least eight-fold stepped cross section.
